(19) United States
(12) Patent Application Publication
(10) Pub. No.: US 2010/0097973 A1
(43) Pub. Date: Apr. 22, 2010

(54) METHOD AND APPARATUS FOR IDLE MODE NOTIFICATION IN CELLULAR COMMUNICATIONS SYSTEM

(75) Inventors: Qi WU, Beijing (CN); Zongchuang LIANG, Beijing (CN)

Correspondence Address: Jefferson IP Law, LLP, 1130 Connecticut Ave., NW, Suite 420, Washington, DC, 20036, US

(73) Assignees: SAMSUNG ELECTRONICS CO. LTD., Suwon-si (KR); BEIJING SAMSUNG TELECOM R & D CENTER, Beijing (CN)

(21) Appl. No.: 12/580,839

(22) Filed: Oct. 16, 2009

(30) Foreign Application Priority Data
Oct. 17, 2008 (CN) 200810170607.9

(51) Int. Cl. H04H 20/71; H04W 4/00

(52) U.S. Cl. 370/312; 370/338

(57) ABSTRACT

An apparatus and method for idle mode notification in a cellular communications system is provided. A user transmits, prior to entering an idle mode, a de-registration request message to a Base Station (BS) which then transmits a Dynamic Service Addition REQuest (DSA-REQ) message to the user and adds the user to a multicast group for the idle mode, and enters the idle mode. The BS transmits an idle mode notification to the user using a Multicast/Broadcast Service MAP (MBS_MAP), and the user receives the idle mode notification, wherein the user switches to a unicast carrier to perform network reentry if the idle mode notification is a network reentry notification. The idle mode notification is considered as a service of an MBS type. When a user enters the idle mode, the BS actively invites the user to join the multicast group for idle mode notification if the MBS operates on a dedicated carrier.

### PRIORITY

This application claims the benefit under 35 U.S.C. §119(a) of a Chinese patent application filed on Oct. 17, 2008 in the Chinese Intellectual Property Office and assigned serial number 200810170607.9, the entire disclosure of which is hereby incorporated by reference.

### BACKGROUND OF THE INVENTION

1. Field of the Invention:

The present invention relates to cellular system. More particularly, the present invention relates to a method and an apparatus for idle mode notification when a dedicated channel is used for Multicast/Broadcast Service (MBS).

2. Description of the Related Art:

In an 802.16e system, the MBS and an ordinary unicast service operate on the same carrier while being divided temporally. That is, the MBS and the unicast service occupy different Orthogonal Frequency Division Multiple Access (OFDMA) time-frequency grids. According to the requirements of the 802.16m system, the MBS can use a dedicated carrier, i.e., the MBS and the unicast service can operate on different frequency points.

For an 802.16e system, an idle mode is defined as a state in which a user de-registers from a current base station such that no normal unicast message can be received. When a user has no data or call to transmit, the user can enter the idle mode. Therefore, no handover is required while the user roams among multiple cells. Accordingly, evaluation of a preamble and MAP is not performed for every frame. Thereby, power consumption of the user terminal can be greatly reduced and system resources that would have been used by handovers can be saved. However, in the idle mode, a user needs to perform downlink synchronization with the base station periodically to receive an idle mode notification message in order to determine whether there is any voice call or data addressed to the user.

In an 802.16m system, if the MBS operates on a dedicated carrier, a user in the idle state can receive a digital multimedia broadcast or watch mobile TV by means of the MBS. However, a prior protocol requires the user to periodically switch to a unicast frequency point in order to determine whether there is any voice call or data addressed to the user. Accordingly, this may cause data loss and thus the degradation of Quality of Service (QoS) since the data multicast/broadcast will not pause for an individual user. In addition, switching among multiple frequency points will increase overhead, such as uplink/downlink synchronization for the user, and will increase the power consumption.

Accordingly, a need exists for an improved apparatus and method for idle mode notification in a cellular communication system.

### SUMMARY OF THE INVENTION

An aspect of the present invention is to address at least the above-mentioned problems and/or disadvantages and to provide at least the advantages described below. Accordingly, an aspect of the present invention is to provide a method and an apparatus for idle mode notification in a cellular communications system.

In accordance with an aspect of the present invention, a method for idle mode notification by a Base Station (BS) in a cellular communications system is provided. The method includes configuring a Multicast/Broadcast Service MAP (MBS-MAP) for MBS, and transmitting an idle mode notification to at least one user in an idle mode using the MBS-MAP, wherein the idle mode notification indicates that the user at least one of waits for the next MBS-MAP and switches to a unicast channel to perform network reentry.

In accordance with another aspect of the present invention, a method for receiving idle mode notification by a user in a cellular communications system is provided. The method includes entering an idle mode, receiving, from a BS, an idle mode notification using an MBS-MAP for MBS, and switching to a unicast channel to perform network reentry if the idle mode notification comprises a network reentry notification.

In accordance with yet another aspect of the present invention, an apparatus of a Mobile Station (MS) for receiving idle mode notification in a cellular communications system is provided. The apparatus includes a transceiver for receiving, from a BS, an idle mode notification using an MBS-MAP for MBS when the mobile station enters an idle mode, and a controller for switching to a unicast channel to perform network reenter if the idle mode notification is a network reenter notification.

According to an exemplary embodiment of the present invention, the idle mode notification is considered as a service of multicast/broadcast type. When a user enters the idle mode, the base station actively invites the user to join the multicast group for idle mode notification if the MBS operates on a dedicated channel. With the present invention, switching in the idle mode can be avoided for a user subscribing to a multicast service and signaling overhead dedicated for the idle mode notification can also be saved.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a signal flow for entering an idle mode initiated by a user according to an exemplary embodiment of the present invention;

FIG. 2 illustrates a signal flow for entering an idle mode initiated by a Base Station (BS) according to an exemplary embodiment of the present invention;

FIG. 3 illustrates a signal flow for entering an idle mode initiated by a BS according to an exemplary embodiment of the present invention;

FIG. 4 illustrates a signal flow in which a BS transmits an idle mode notification to a user by means of multicast/broadcast according to an exemplary embodiment of the present invention;

FIG. 5 illustrates user actions in a signal flow for entering an idle mode initiated by a user according to an exemplary embodiment of the present invention;

FIG. 6 illustrates BS actions in a signal flow for entering an idle mode initiated by a user according to an exemplary embodiment of the present invention;

FIG. 7 illustrates user actions in signal flows for entering an idle mode initiated by a BS according to an exemplary embodiment of the present invention;

FIG. 8 illustrates BS actions in signal flows for entering an idle mode initiated by the BS according to an exemplary embodiment of the present invention;

FIG. 9 illustrates user actions in an idle mode according to an exemplary embodiment of the present invention;

FIG. 10 illustrates BS actions in an idle mode according to an exemplary embodiment of the present invention;

FIG. 11 illustrates a second flow for entering an idle mode initiated by a user according to an exemplary embodiment of the present invention;

FIG. 12 illustrates a signal flow for entering an idle mode initiated by a BS according to an exemplary embodiment of the present invention;

FIG. 13 illustrates a signal flow for entering an idle mode initiated by a BS according to an exemplary embodiment of the present invention;

FIG. 14 illustrates user actions in a signal flow for entering an idle mode initiated by a user according to an exemplary embodiment of the present invention;

FIG. 15 illustrates BS actions in a signal flow for entering an idle mode initiated by a user according to an exemplary embodiment of the present invention;

FIG. 16 illustrates actions of an MCBCS server according to an exemplary embodiment of the present invention;

FIG. 17 illustrates actions of an Accounting Authentication Authorization (AAA) server according to an exemplary embodiment of the present invention;

FIG. 18 illustrates Base Station (BS) actions in a signal flow for entering an idle mode initiated by a BS according to an exemplary embodiment of the present invention;

FIG. 19 illustrates user actions in a signal flow for entering an idle mode initiated by a BS according to an exemplary embodiment of the present invention;

FIG. 20 illustrates base station actions in a signal flow for entering an idle mode initiated by a BS according to an exemplary embodiment of the present invention; and

FIG. 21 illustrates user actions in a signal flow for entering an idle mode initiated by a BS according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

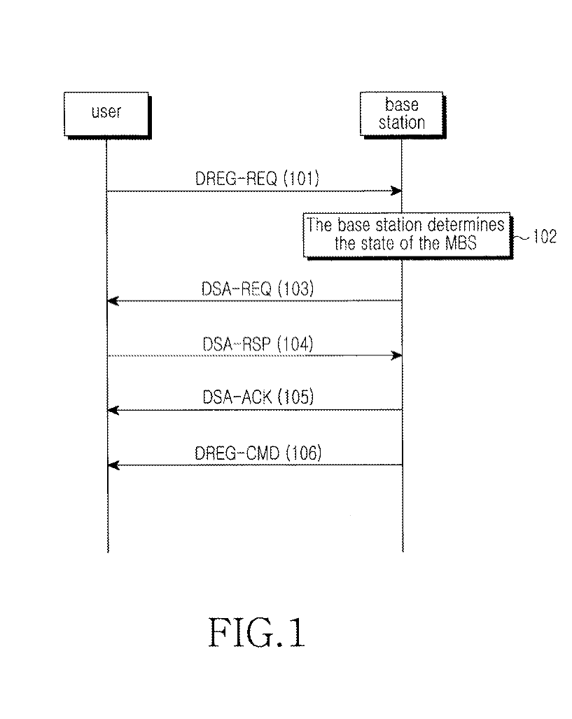

FIG. 1 illustrates a signal flow for entering an idle mode initiated by a user according to an exemplary embodiment of the present invention.

Referring to FIG. 1, at step 101, the user (i.e., a Mobile Station (MS)) transmits to a Base Station (BS) a De-REGistration REQuest (DREG-REQ) message in which a De-registration_Request_Code field is set as a predefined value (e.g., 1). The setting of the De-registration_Request_Code field to the predefined value indicates that the user wants to de-register from the BS and enter an idle mode.

At step 102, after receiving the DREG-REQ message from the user, the BS determines to perform different steps according to the channel deployment of the Multicast/Broadcast Service (MBS). The channel deployment represents a carrier, a subcarrier, a frequency band, a time/frequency region, and the like. Thereinafter, each channel corresponds to a carrier. More particularly, if the MBS and a unicast service are deployed on different channels, e.g., different carriers, the BS proceeds with steps 103 through 106. If the MBS and the unicast service are deployed on same channel, e.g., same carrier, the BS proceeds directly with step 106.

At step 103, the BS transmits a Dynamic Service Addition REQuest (DSA-REQ) message to the user. The header of the message may include a Connection IDentification (CID) which is set as the primary connection identification of the user (i.e., the primary connection identification allocated by the BS when the user registers with the BS). The DSA-REQ message further includes at least one of a Type/Length/Value (TLV) indicator for the MBS, indicating that the MBS is a multi-BS MBS in which multiple BSs transmit the same data with the same modulation and coding scheme in the same time-frequency grid, a TLV indicator for an MBS content identifier which is a content identifier corresponding to the idle mode notification, a transaction identifier specified by the BS, and a Service Flow IDentifier (SFID) indicating a Quality of Service (QoS) condition of the service stream and a CID which is set as connection identification for the idle mode notification. As stated above, a multi-BS MBS represents an MBS in which multiple BSs transmit the same data on the same time-frequency grid using the same modulation and coding. On the other hand, an MBS that is not a multi-BS MBS represents an MBS in which a single BS transmits the same data to multiple users.

At step 104, the user transmits a DSA ReSPonse (DSA-RSP) message to the BS. The header of this message may include a CID field which is set as the primary connection identification of the user. The DSA-RSP message may further include at least one of a TLV for the MBS indicating that the MBS is a multi-BS MBS, a TLV for a MBS content identifier, which is equal to the corresponding value in the received DSA-REQ message, a transaction identifier which is equal to the transaction identifier specified by the BS in the DSA-REQ message, and an SFID and a CID, which are equal to the SFID and CID specified in the DSA-REQ message, respectively.

At step 105, the BS transmits a DSA ACKnowledgement (DSA-ACK) message to the user. The header of this message may include a CID field which is set as the primary connection identification of the user. The DSA-ACK message further includes at least one of a TLV for the MBS indicating that the MBS is a multi-BS MBS, a TLV for an MBS content identifier, which is equal to the corresponding value in the received DSA-RSP message, a transaction identifier which is equal to the transaction identifier specified by the BS in the DSA-RSP message, an SFID and a CID, which are equal to the SFID and CID specified in the DSA-RSP message, respectively.

At step 106, the BS transmits to the user a De-REGistration CoMmanD (DREG-CMD) message in which an Action_Code field is set as a predefined value (e.g., 5) indicating that the BS requires the user to de-register from the BS and enter the idle mode after receiving the message.

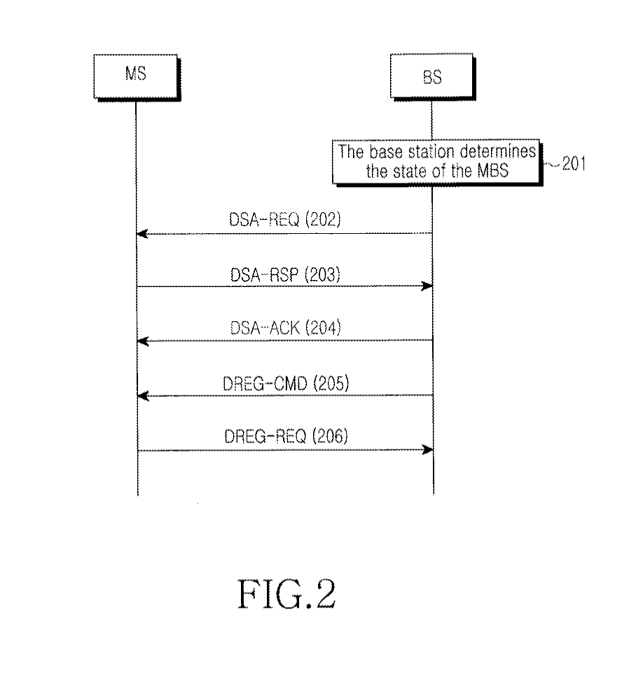

FIG. 2 illustrates a signal flow for entering an idle mode initiated by a BS according to an exemplary embodiment of the present invention.

Referring to FIG. 2, at step 201, the BS determines to perform different steps according to the deployment of the MBS. More particularly, if the MBS and a unicast service are deployed on different carriers, the BS proceeds with steps 202 through 206. If the MBS and the unicast service are deployed on the same carrier, the BS proceeds with steps 205 and 206.

At step 202, the BS transmits a DSA-REQ message to the user. The header of the message may include a CID field, which is set as the primary connection identification of the user. The DSA-REQ message further includes at least one of a TLV for the MBS, indicating that the MBS is a multi-BS MBS, a TLV for an MBS content identifier, which is a content identifier corresponding to the idle mode notification, a transaction identifier specified by the BS, an SFID indicating the QoS condition of the service stream and a CID which is set as connection identification for the idle mode notification.

At step 203, the user transmits a DSA-RSP message to the BS. The header of this message may include a CID field, which is set as the primary connection identification of the user. The DSA-RSP message may further include at least one of a TLV coding for the MBS indicating that the MBS is a multi-BS MBS, a TLV coding for an MBS content identifier, which is equal to the corresponding value in the received DSA-REQ message, a transaction identifier, which is equal to the transaction identifier specified by the BS in the DSA-REQ message, and an SFID and a CID which are equal to the SFID and CID specified in the DSA-REQ message, respectively.

At step 204, the BS transmits a DSA-ACK message to the user. The header of this message may include a CID field which is set as the primary connection identification of the user. The DSA-ACK message may further include at least one of a TLV coding for the MBS indicating that the MBS is a multi-BS MBS, a TLV coding for an MBS content identifier, which is equal to the corresponding value in the received DSA-RSP message, a transaction identifier which is equal to the transaction identifier specified by the BS in the DSA-RSP message, and an SFID and a CID which are equal to the SFID and CID specified in the DSA-RSP message, respectively.

At step 205, the BS transmits to the user a DREG-CMD message in which an Action_Code field is set as a predefined value (e.g., 5) indicating that the BS requires the user to start de-registering from the BS and entering the idle mode after receiving the message.

At step 206, after receiving the DREG-CMD message from the BS, the user transmits to a BS a DREG-REQ message in which De-registration_Request_Code field is set as a predefined value (e.g., 2) to indicate that the user de-registers from the BS and starts entering the idle mode.

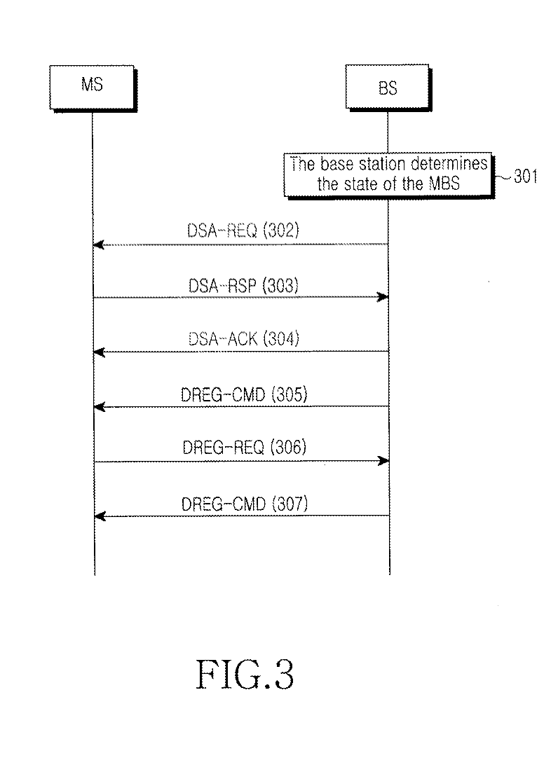

FIG. 3 illustrates a signal flow for entering an idle mode initiated by a BS according to an exemplary embodiment of the present invention.

Referring to FIG. 3, at step 301, the BS determines to perform different steps according to the deployment of the MBS. More particularly, if the MBS and a unicast service are deployed on different carriers, the BS proceeds with steps 302 through 307. If the MBS and the unicast service are deployed on the same carrier, the BS proceeds with steps 305 through 307.

At step 302, the BS transmits a DSA-REQ message to the user. The header of the message may include a CID which is set as the primary connection identification of the user. The DSA-REQ message further includes at least one of a TLV coding for the MBS, indicating that the MBS is a multi-BS MBS, a TLV coding for an MBS content identifier which is a content identifier corresponding to the idle mode notification, a transaction identifier specified by the BS, and an SFID indicating the QoS condition of the service stream and a CID which is set as connection identification for the idle mode notification.

At step 303, the user transmits a DSA-RSP message to the BS. The header of this message may include a CID field which is set as the primary connection identification of the user. The DSA-RSP message may further include at least one of a TLV coding for the MBS indicating that the MBS is a multi-BS MBS, a TLV coding for an MBS content identifier, which is equal to the corresponding value in the received DSA-REQ message, a transaction identifier, which is equal to the transaction identifier specified by the BS in the DSA-REQ message, and an SFID and a CID, which are equal to the SFID and CID specified in the DSA-REQ message, respectively.

At step 304, the BS transmits a DSA-ACK message to the user. The header of this message may include a CID field which is set as the primary connection identification of the user. The DSA-ACK message may further include at least one of a TLV coding for the MBS indicating that the MBS is a multi-BS MBS, a TLV coding for an MBS content identifier, which is equal to the corresponding value in the received DSA-RSP message, a transaction identifier, which is equal to the transaction identifier specified by the BS in the DSA-RSP message, and an SFID and a CID which are equal to the SFID and CID specified in the DSA-RSP message, respectively.

At step 305, the BS transmits to the user a DREG-CMD message in which an Action_Code field is set as a predefined value (e.g., 5) to indicate that the BS requires the user to start de-registering from the BS and entering the idle mode after receiving the message. The DREG-CMD message may further include a TLV coding for REQ-Duration, indicating the time period during which the BS continues waiting for a DREG-REQ message from the user.

At step 306, after receiving the DREG-CMD message from the BS, the user waits until the time duration specified by the TLV coding for REQ-Duration included in the message has passed, then transmits to the BS a DREG-REQ message in which a De-registration_Request_Code field is set as a predefined value (e.g., 1) to indicate that the user wants to de-register from the BS and starts entering the idle mode.

At step 307, the BS transmits to the user a DREG-CMD message in which an Action_Code field is set as a predefined value (e.g., 5) to indicate that the BS requires the user to de-register from the BS immediately and enter the idle mode after receiving the message.

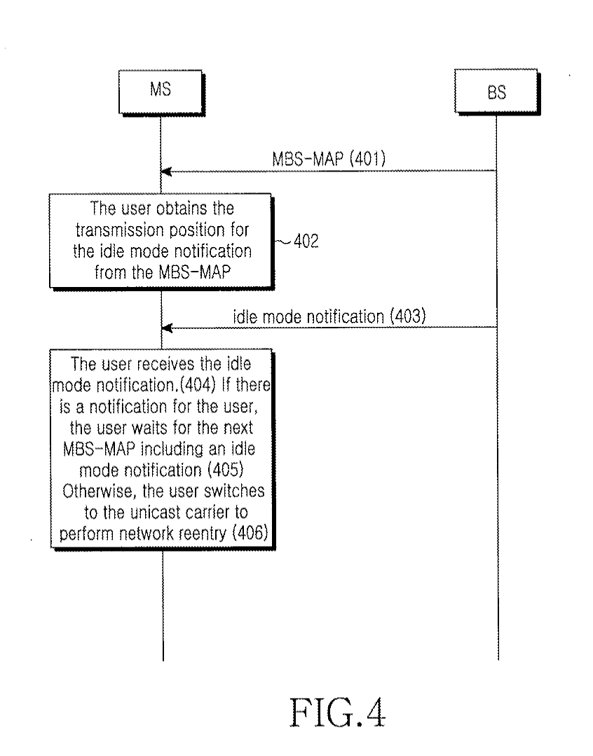

FIG. 4 illustrates a signal flow in which a BS transmits an idle mode notification to a user by means of multicast/broadcast according to an exemplary embodiment of the present invention.

Referring to FIG. 4, at step 401, the BS transmits to the user an MBS-MAP message which includes the transmission position for the idle mode notification and the time when the next MBS-MAP message will be transmitted. The MBS-MAP message is used for allocating time/frequency resources and transmitting control information for MBS and may be transmitted on a dedicated MBS channel for MBS (e.g., a dedicated MBS carrier). Similarly, the next MBS-MAP message may include the transmission position in which the next idle mode notification will be transmitted.

At step 402, the user receives the MBS-MAP message from which the transmission position for the idle mode notification is found. Also, the MBS-MAP message may indicate the time when the next MBS-MAP message including the transmission position of the idle mode notification will be transmitted.

At step 403, the BS transmits, at the transmission position for the idle mode notification, to the user the idle mode notification which includes the user's Media Access Control (MAC) address hash and an action code. In an exemplary embodiment, another identifier may be used for identifying the idle mode notification. Also, a mask using an identifier of the user or inclusion of the identifier may be used rather than a hash of the MAC address.

At step 404, the user receives the idle mode notification at the transmission position for the idle mode notification. If the user's own MAC address hash or other identifier of the user is not included in the notification, or the user's own MAC address hash or other identifier is included in the notification but the corresponding action code indicates no action, the process proceeds with step 405. If the user's own MAC address hash is included in the notification and the corresponding action code indicates a network reentry, the process proceeds with step 406.

At step 405, the user waits for the next MB S-MAP including an idle mode notification.

At step 406, the user terminates the idle mode and switches to the unicast carrier on which a unicast service is allocated to perform network reentry.

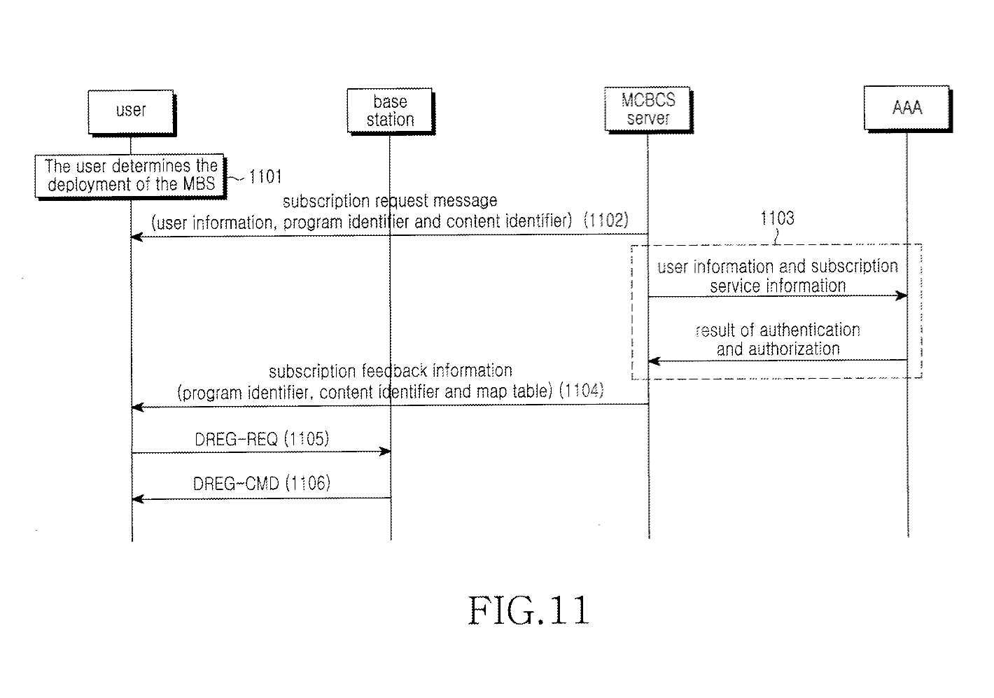

FIG. 11 illustrates a signal flow for entering an idle mode initiated by a user according to an exemplary embodiment of the present invention.

Referring to FIG. 11, at step 1101, the user determines to perform different steps according to the deployment of the MBS. More particularly, if the MBS and a unicast service are deployed on different carriers, the user proceeds with steps 1102 through 1106. If the MBS and the unicast service are deployed on the same carrier, the user proceeds with steps 1105 and 1106.

At step 1102, the user transmits to a MultiCast and BroadCast Service (MCBCS) server a subscription request message which includes user information (i.e., a Network Access Identifier (NAI)) and subscription service information (i.e., a program identifier and a content identifier). The fields of program identifier and the content identifier are set as values corresponding to the multicast group for the idle mode notification.

At step 1103, the MCBCS server interacts with an Accounting, Authentication, and Authorization server (AAA) server to perform authentication and authorization on the user information. More particularly, the MCBCS server transmits the user information and subscription service information to the AAA server which then authenticates and verifies whether the user is authorized to receive the requested service according to the user information and the subscription service information and feeds the result back to the MCBCS server.

At step 1104, the MCBCS server feeds information back to the user based on the result of the authentication and authorization. More particularly, if the authentication and authorization succeeds, the MCBCS server transmits a subscription response message including a map table to the user. Otherwise, the MCBCS server transmits an error indication message to the user.

At step 1105, the user transmits to a BS a DREG-REQ message in which a De-registration_Request_Code field is set to indicate that the user wants to de-register from the BS and starts entering the idle mode.

At step 1106, the BS transmits to the user a DREG-CMD message in which an Action_Code field is set to indicate that the BS requires the user to de-register from the BS and enter the idle mode after receiving the message.

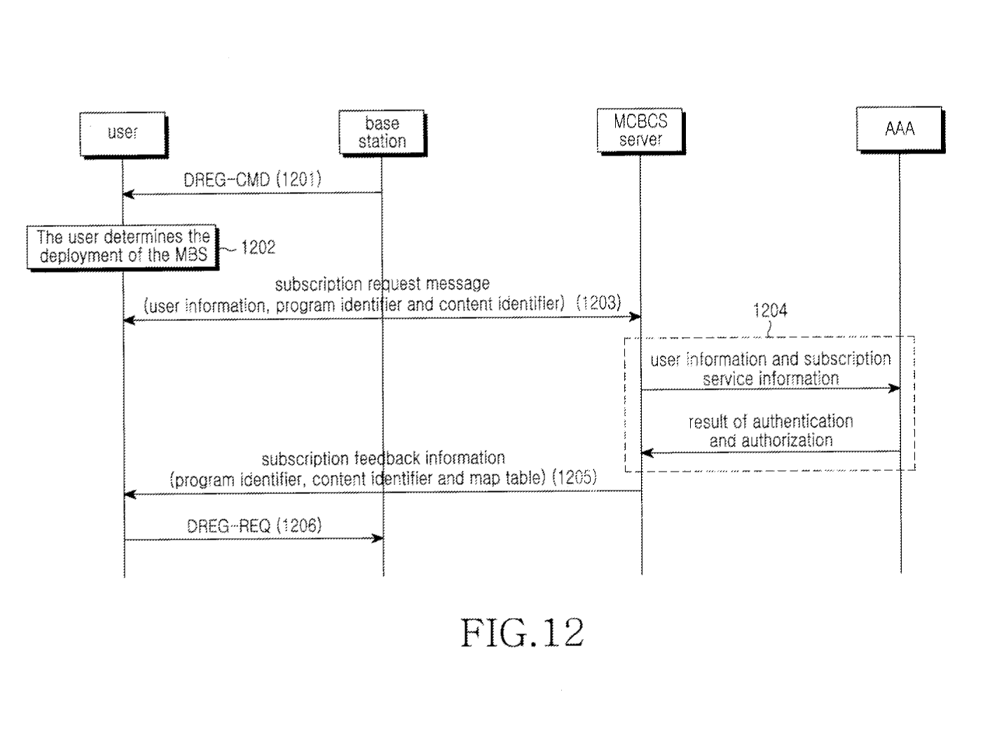

FIG. 12 illustrates a signal flow for entering an idle mode initiated by a user according to an exemplary embodiment of the present invention.

Referring to FIG. 12, at step 1201, the BS transmits to the user a DREG-CMD message in which an Action_Code field is set to indicate that the BS requires the user to start de-registering from the BS and entering the idle mode after receiving the message.

At step 1202, the user determines to perform different steps according to the deployment of the MBS. More particularly, if the MBS and a unicast service are deployed on different carriers, the user proceeds with steps 1203 through 1206. If the MBS and the unicast service are deployed on the same carrier, the user proceeds with step 1206.

At step 1203, the user transmits to an MCBCS server a subscription request message which includes user information NAI, a program identifier and a content identifier (e.g., subscription service information). The fields of the program identifier and the content identifier are set as values corresponding to the multicast group for the idle mode notification.

At step 1204, the MCBCS server interacts with an AAA server to perform authentication and authorization on the user information. More particularly, the MCBCS server transmits the user information and subscription service information to the AAA server which then authenticates and verifies whether the user is authorized to receive the requested service according to the user information and the subscription service information and feeds the result back to the MCBCS server.

At step 1205, the MCBCS server feeds information back to the user based on the result of the authentication and authorization. More particularly, if the authentication and authorization succeeds, the MCBCS server transmits a subscription response message including a map table to the user. Otherwise, the MCBCS server transmits an error indication message to the user.

At step 1206, the user transmits to a BS a DREG-REQ message in which De-registration_Request_Code field is set to indicate that the user de-registers from the BS and starts entering the idle mode.

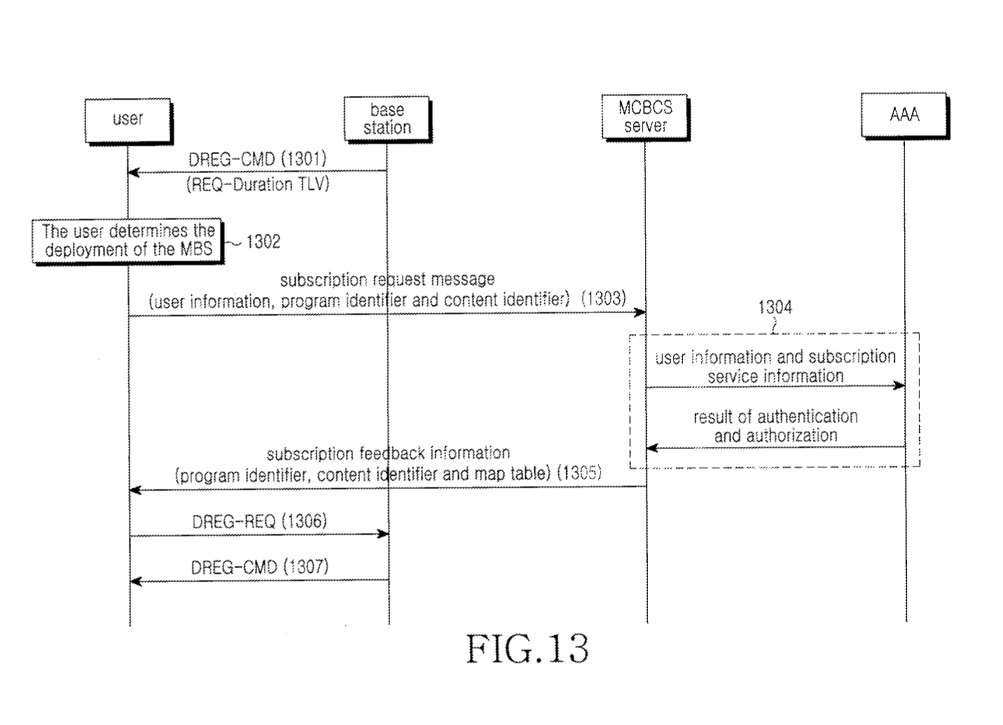

FIG. 13 illustrates a signal flow for entering an idle mode initiated by a user according to an exemplary embodiment of the present invention.

Referring to FIG. 13, at step 1301, the BS transmits to the user a DREG-CMD message in which an Action_Code field is set to indicate that the BS requires the user to start de-registering from the BS and entering the idle mode after receiving the message. The DREG-CMD message further includes a TLV coding for REQ-Duration, indicating the time period during which the BS continues to wait for a DREG-REQ message from the user.

At step 1302, the user determines to perform different steps according to the deployment of the MBS. More particularly, if the MBS and a unicast service are deployed on different carriers, the user proceeds with steps 1303 through 1307. If the MBS and the unicast service are deployed on same carrier, the user proceeds with steps 1306 and 1307.

At step 1303, the user transmits to an MCBCS server a subscription request message which includes user information NAI, a program identifier and a content identifier (e.g., subscription service information). The fields of program identifier and the content identifier are set as values corresponding to the multicast group for the idle mode notification.

At step 1304, the MCBCS server interacts with an AAA server to perform authentication and authorization on the user information. More particularly, the MCBCS server transmits the user information and subscription service information to the AAA server which then authenticates and verifies whether the user is authorized to receive the requested service according to the user information and the subscription service information and feeds the result back to the MCBCS server.

At step 1305, the MCBCS server feeds information back to the user based on the result of the authentication and authorization. More particularly, if the authentication and authorization succeeds, the MCBCS server transmits a subscription response message including a map table to the user. Otherwise, the MCBCS server transmits an error indication message to the user.

At step 1306, the user waits until the time duration specified by the TLV coding for REQ-Duration included in the DREG-CMD message has passed, then transmit to a BS a DREG-REQ message in which a De-registration_Request_Code field is set to indicate that the user wants to de-register from the BS and starts entering the idle mode.

At step 1307, the BS transmits to the user a DREG-CMD message in which an Action_Code field is set to indicate that the BS requires the user to de-register from the BS immediately and enter the idle mode after receiving the message.

### A First Exemplary Embodiment: The Signal Flow for Entering Idle Mode Initiated by a User

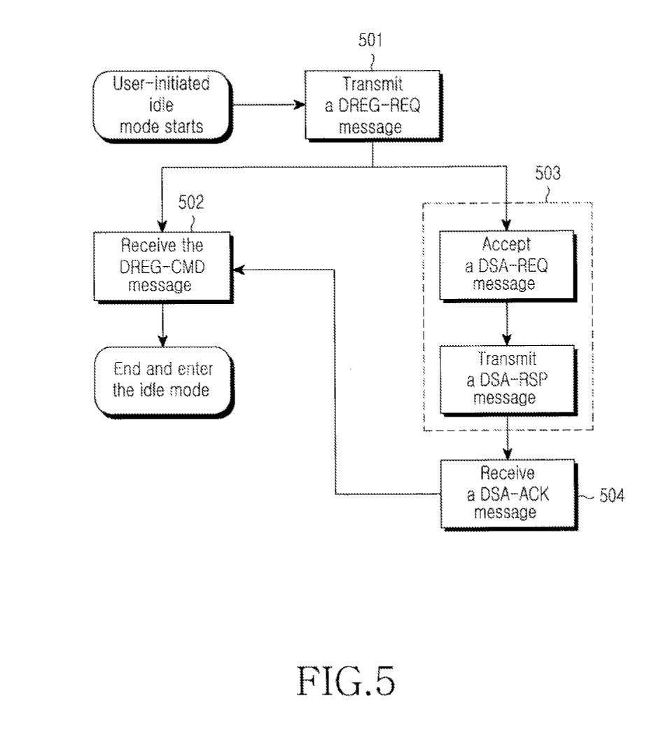

FIG. 5 illustrates user actions in a signal flow for entering an idle mode initiated by a user according to an exemplary embodiment of the present invention.

Referring to FIG. 5, at step 501, if a user wants to enter the idle mode, a DREG-REQ message is constructed and transmitted to a BS, indicating that the user wants to de-register from the BS, and the user starts entering the idle mode.

At step 502, if the user receives a DREG-CMD message from the BS, the user de-registers from the BS and enters the idle mode.

At step 503, if the user receives a DSA-REQ message from the BS, the user transmits a DSA-RSP message to the BS in response, in order to join the multicast group for the idle mode notification.

At step 504, if the user receives a DSA-ACK message from the BS, the user proceeds to step 502 and continues to wait for a DREG-CMD message.

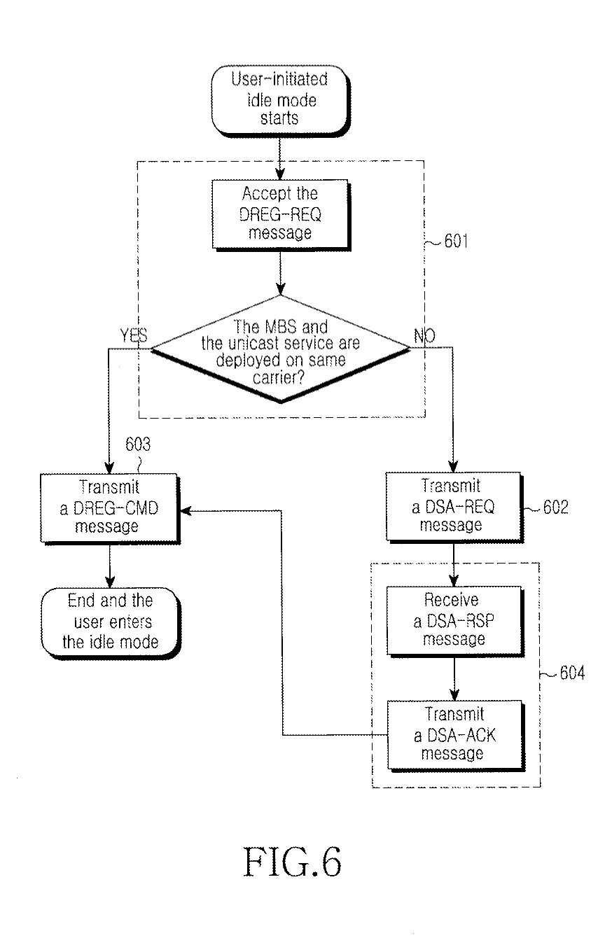

FIG. 6 illustrates BS actions in a signal flow for entering an idle mode initiated by a user according to an exemplary embodiment of the present invention.

Referring to FIG. 6, at step 601, after receiving a DREG-REQ message from the user, the BS determines if the MBS and unicast are deployed on the same carrier. If the BS determines that the MBS and unicast are deployed on different carriers, the BS proceeds with step 602. Otherwise, the BS proceeds with step 603.

At step 602, the BS transmits a DSA-REQ message to the user so as to invite the user to join the multicast group.

At step 603, the BS transmits a DREG-CMD message to the user so as to require the user to de-register from the BS and the user enters the idle mode.

At step 604, after receiving a DSA-RSP message from the user, the BS transmits a DSA-ACK message to the user, indicating that the BS confirms that the user has joined the multicast group. Then, the BS proceeds to step 603.

### A Second Exemplary Embodiment: The Signal Flows for Entering Idle Mode Initiated by a BS

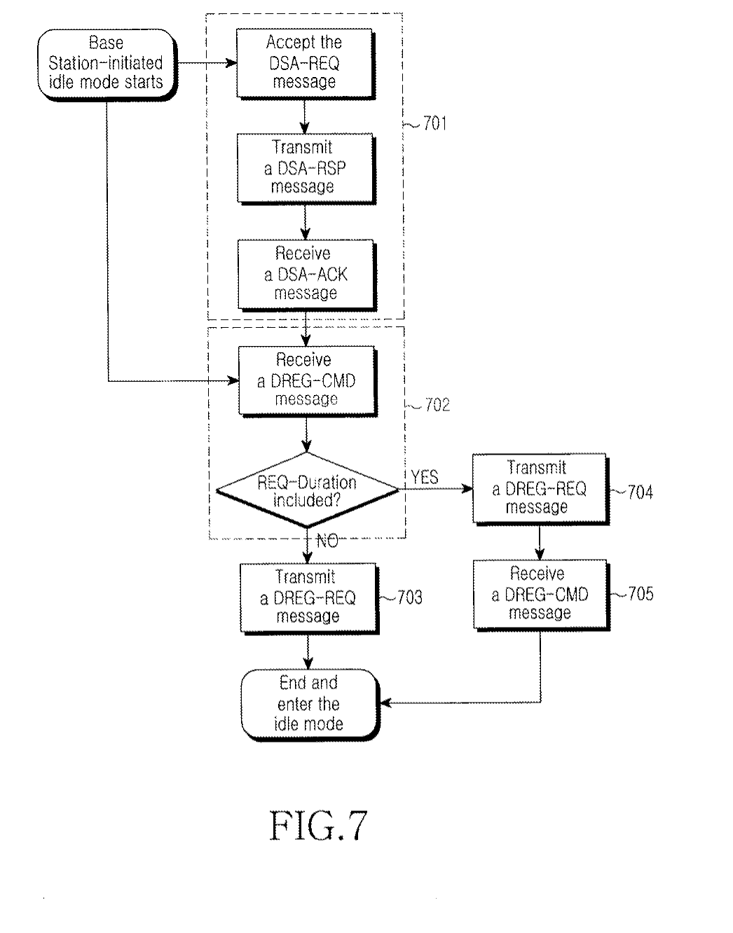

FIG. 7 illustrates user actions in signal flows for entering an idle mode initiated by a BS according to an exemplary embodiment of the present invention.

Referring to FIG. 7, at step 701 if a user receives from a BS a DSA-REQ message, the user transmits a DSA-RSP message to the BS in response and receives a DSA-ACK message from the BS. Then, the user joins the multicast group for the idle mode notification.

At step 702, the user receives, from the BS, a DREG-CMD message and determines if the DREG-CMD message includes a REQ-Duration. If it is determined that the DREG-CMD message does not include the REQ-Duration, the user proceeds with step 703. Otherwise, the user proceeds with steps 704 and 705.

At step 703, the user transmits a DREG-REQ message to the BS and enters the idle mode.

At step 704, the user transmits a DREG-REQ message to the BS.

At step 705, the user receives a DREG-CMD message from the BS and enters the idle mode.

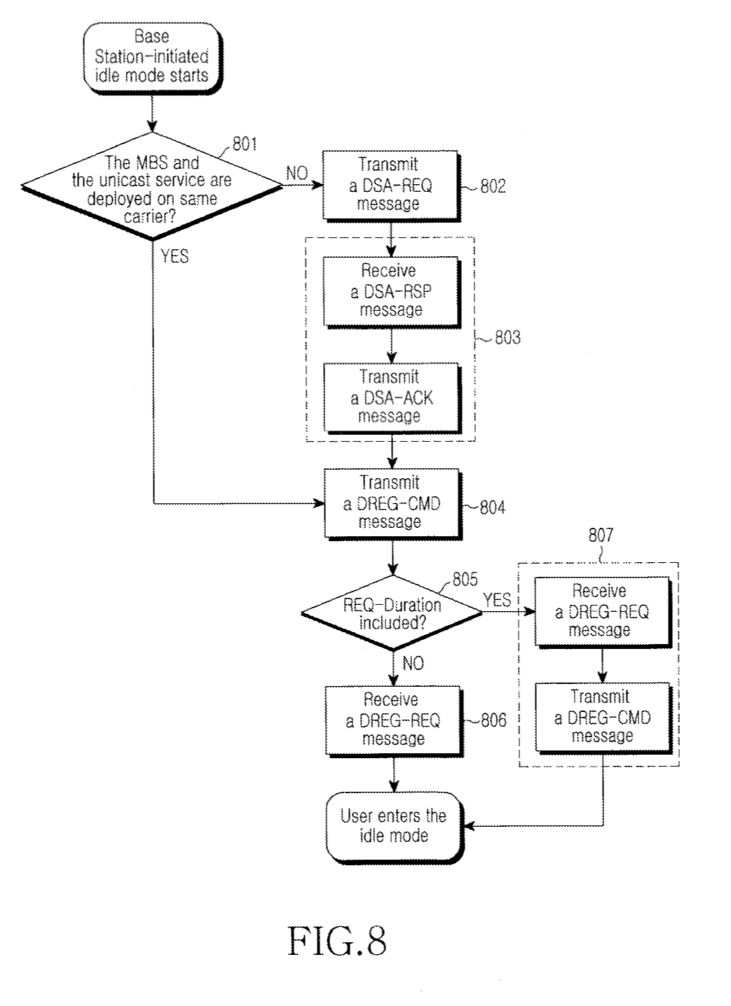

FIG. 8 illustrates BS actions in signal flows for entering an idle mode initiated by the BS according to an exemplary embodiment of the present invention.

Referring to FIG. 8, at step 801, if the BS wants the user to enter the idle mode, it first determines whether the MBS and the unicast service are deployed on different carriers. If so, the BS proceeds with step 802. Otherwise, the BS proceeds with step 804.

At step 802, the BS transmits a DSA-REQ message to the user so as to invite the user to join the multicast group.

At step 803, after receiving the DSA-RSP message from the user, the BS transmits a DSA-ACK message to the user, indicating that the BS confirms that the user has joined the multicast group.

At step 804, the BS transmits the DREG-CMD message to the user so as to require the user to de-register from the BS.

At step 805, the BS determines if a REQ-Duration is included in the DREG-CMD message. If the BS determines that a REQ-Duration is not included in the DREG-CMD message transmitted to the user, the BS proceeds with step 806. Otherwise, the BS proceeds with step 807.

At step 806, the BS receives the DREG-REQ message from the user and the user enters the idle mode.

At step 807, the BS transmits a DREG-CMD message to the user after receiving the DREG-REQ message from the user and the user enters the idle mode.

### A Third Exemplary Embodiment: a BS Transmits an Idle Mode Notification by Means of Multicast/Broadcast

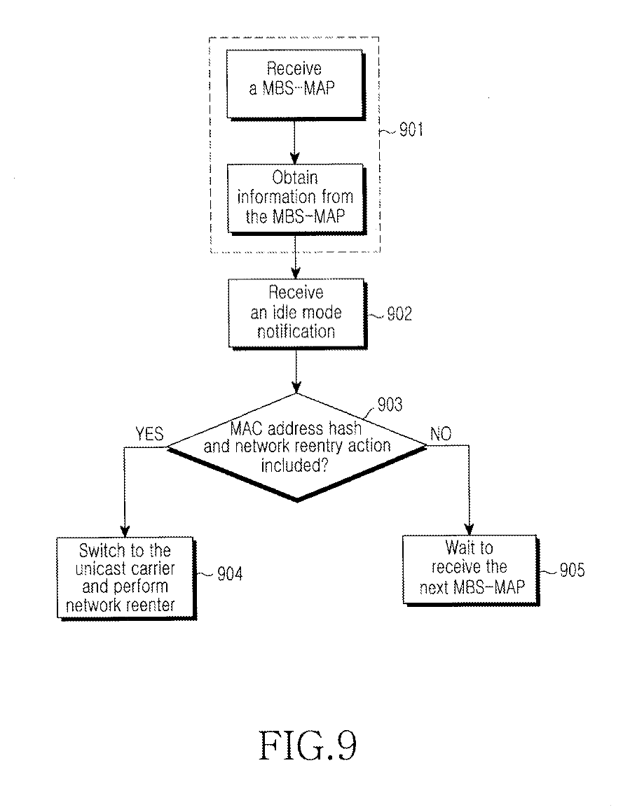

FIG. 9 illustrates user actions in an idle mode according to an exemplary embodiment of the present invention.

Referring to FIG. 9, at step 901, a user receives an MBS-MAP from which the transmission position for the idle mode notification is found, and also the time when the next MBS-MAP including the transmission position of the idle mode notification will be transmitted.

At step 902, the user receives the idle mode notification at the transmission position for the idle mode notification.

At step 903, the user evaluates the notification state associated with itself in the idle mode notification. If the user's own MAC address hash is not included in the notification, or the user's own MAC address hash is included in the notification but the corresponding action code indicates no action, the user proceeds to step 905. If the user's own MAC address hash is included in the notification and the corresponding action code is a network reentry, the user proceeds to step 904.

At step 904, the user terminates the idle mode and switches to the unicast carrier to perform network reentry. That is, the user searches for and receives a preamble from the BS, performs downlink synchronization with the BS, performs ranging and uplink synchronization with the BS and then registers with the BS so as to reenter active mode and perform normal uplink and downlink communication with the BS.

At step 905, the user waits to receive the next MBS-MAP.

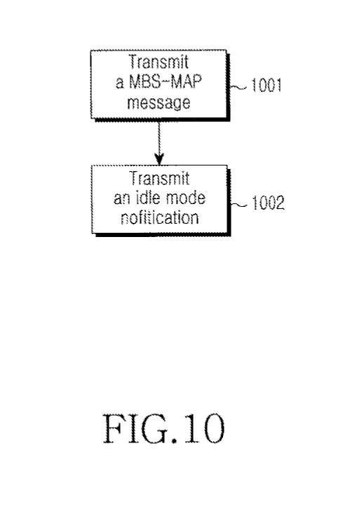

FIG. 10 illustrates BS actions in an idle mode according to an exemplary embodiment of the present invention.

Referring to FIG. 10, at step 1001, the BS transmits to the user an MBS-MAP which includes the transmission position for the idle mode notification and the time when the next MBS-MAP including the transmission position of the idle mode notification will be transmitted.

At step 1002, the BS transmits to the user, at the transmission position for the idle mode notification, the idle mode notification which includes the user's MAC address hash and an action.

### A Fourth Exemplary Embodiment: Signal Flow for Entering the Idle Mode Initiated by a User

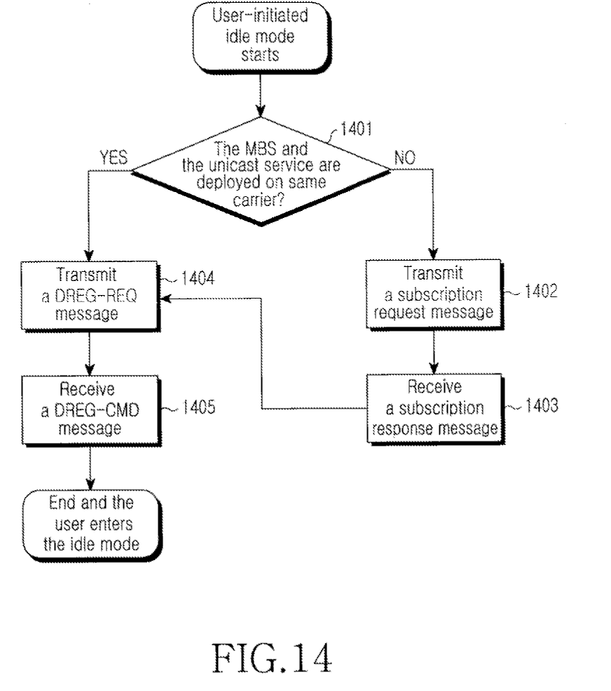

FIG. 14 illustrates user actions in a signal flow for entering an idle mode initiated by a user according to an exemplary embodiment of the present invention.

Referring to FIG. 14, at step 1401, if the user wants to enter the idle mode, the user determines to perform different steps according to the deployment of the MBS and the unicast service. If the MBS and the unicast service are deployed on the same carrier, the user proceeds with step 1404. Otherwise the user proceeds with step 1402.

At step 1402, the user constructs a subscription request message and transmits it to the MCBCS server.

At step 1403, if the user receives from the MCBCS server a subscription response message, the user proceeds with step 1404.

At step 1404, the user constructs a DREG-REQ message and transmits it to the BS, indicating that the user wants to de-register from the BS and starts entering the idle mode.

At step 1405, if the user receives a DREG-CMD message from the BS, the user de-registers from the BS and starts entering the idle mode.

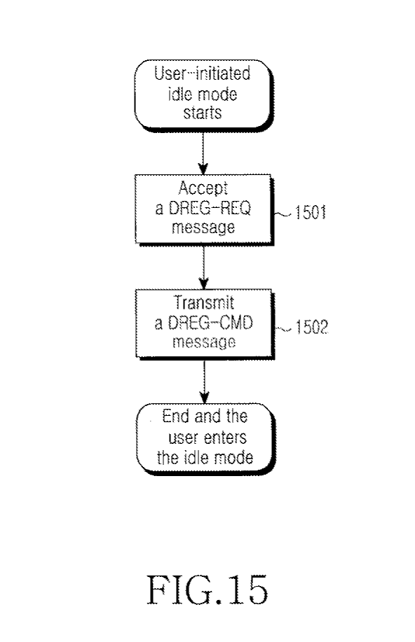

FIG. 15 illustrates BS actions in a signal flow for entering an idle mode initiated by a user according to an exemplary embodiment of the present invention.

Referring to FIG. 15, at step 1501, after receiving a DREG-REQ message from the user, the BS proceeds with step 1502.

At step 1502, the BS transmits a DREG-CMD message to the user so as to require the user to de-register from the BS.

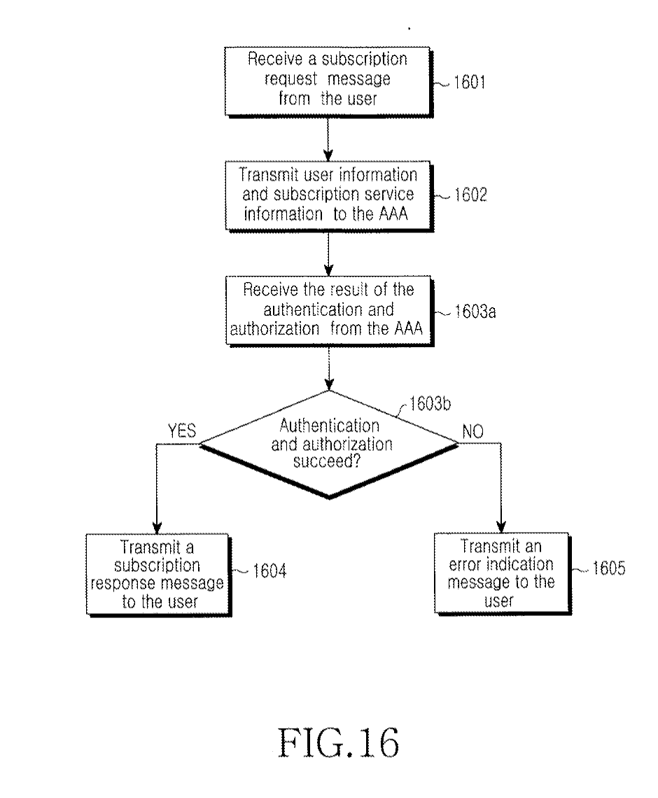

FIG. 16 illustrates actions of an MCBCS server according to an exemplary embodiment of the present invention.

Referring to FIG. 16, at step 1601, the MCBCS server receives a subscription request message from a user.

At step 1602, the MCBCS server transmits user information and subscription service information to an AAA server so as to request the AAA server to perform authentication and authorization.

At step 1603a, the MCBCS server receives the authentication and authorization result from the AAA server and in step 1603b determines whether the authentication and authorization result is successful.

At step 1604, if the authentication and authorization succeeds, the MCBCS server transmits a subscription response message to the user.

At step 1605, if the authentication and authorization fails, the MCBCS server transmits an error indication message to the user.

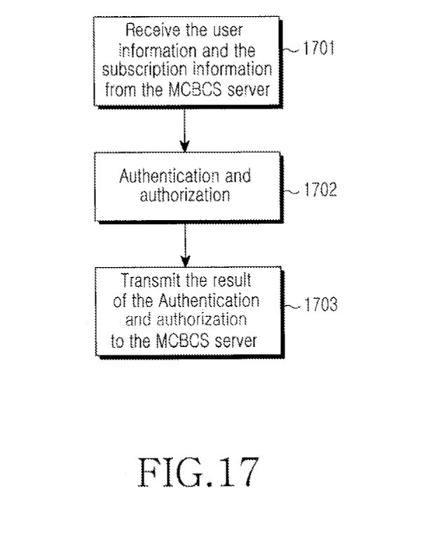

FIG. 17 illustrates actions of an AAA server according to an exemplary embodiment of the present invention.

Referring to FIG. 17, at step 1701, the AAA server receives the user information and subscription service information from the MCBCS server.

At step 1702, the AAA server authenticates and verifies whether the user is authorized to receive the requested service.

At step 1703, the AAA server provides the authentication and authorization result to the MCBCS server.

### A Fifth Exemplary Embodiment: A Signal Flow for Entering the Idle Mode Initiated by a BS

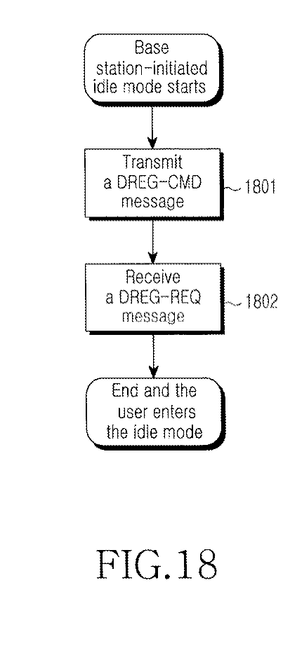

FIG. 18 illustrates BS actions in a signal flow for entering an idle mode initiated by a BS according to an exemplary embodiment of the present invention.

Referring to FIG. 18, at step 1801, if the BS wants the user to enter the idle mode, the BS transmits a DREQ-CMD message to the user so as to require the user to de-register from the BS.

At step 1802, if the BS receives a DREG-REQ message from the user, it recognizes that the user has entered the idle mode.

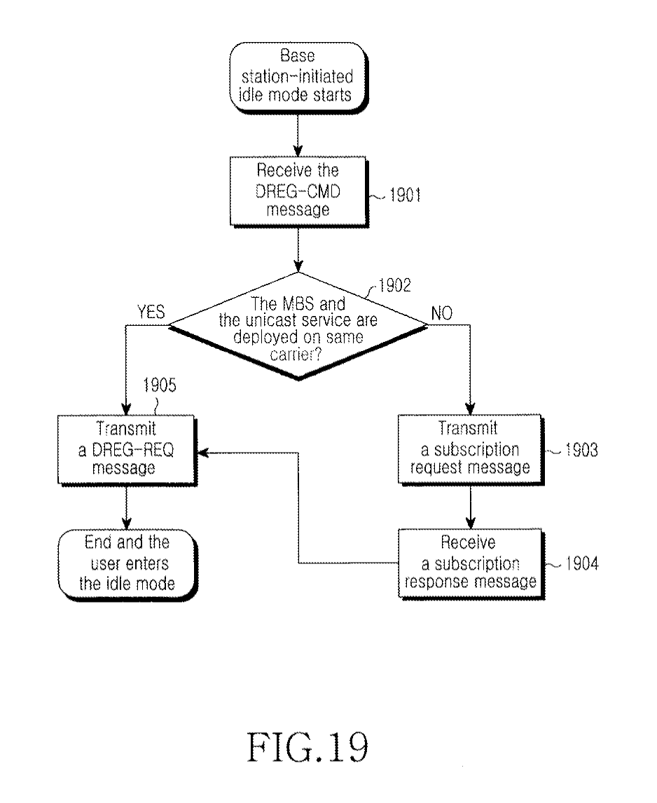

FIG. 19 illustrates user actions in a signal flow for entering an idle mode initiated by a BS according to an exemplary embodiment of the present invention.

Referring to FIG. 19, at step 1901, if the user receives from the BS a DREG-CMD message, the user performs different actions according to the deployment of the MBS and the unicast service.

At step 1902, the BS determines if the MBS and the unicast service are deployed on same carrier. If it is determined that the MBS and the unicast service are deployed on same carrier, the user proceeds with step 1905. Otherwise the user proceeds with step 1903.

At step 1903, the user constructs a subscription request message and transmits it to the MCBCS server.

At step 1904, the user receives a subscription response message from the MCBCS server and proceeds to step 1905.

At step 1905, the user transmits a DREG-REQ message to the BS, de-registers from the BS and enters the idle mode.

As discussed above, FIG. 16 illustrates actions of an MCBCS server and FIG. 17 illustrates actions of an AAA server according to exemplary embodiments of the present invention. The actions of the MCBCS server and the AAA server for entering the idle mode are substantially the same regardless if the idle mode is entered at the initiation of the user or the BS. Accordingly, they will not be described again for sake of convenience.

### A Sixth Exemplary Embodiment: A Signal Flow for Entering the Idle Mode Initiated by a BS

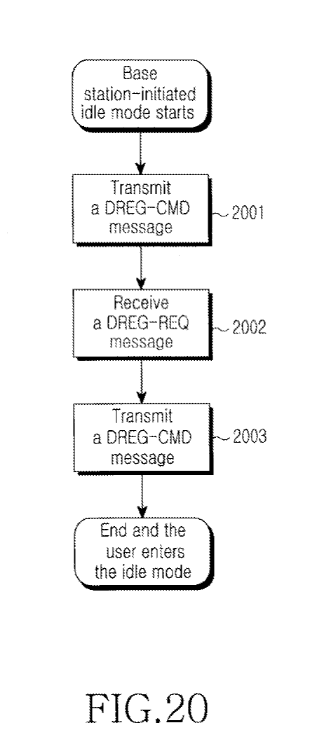

FIG. 20 illustrates BS actions in a signal flow for entering an idle mode initiated by the BS according to an exemplary embodiment of the present invention.

Referring to FIG. 20, at step 2001, if the BS wants the user to enter the idle mode, it transmits a DREQ-CMD message including a REQ-Duration field to the user, so as to require the user to de-register from the BS.

At step 2002, the BS receives a DREG-REQ message from the user.

At step 2003, the BS transmits a DREG-CMD message to the user and the user enters the idle mode.

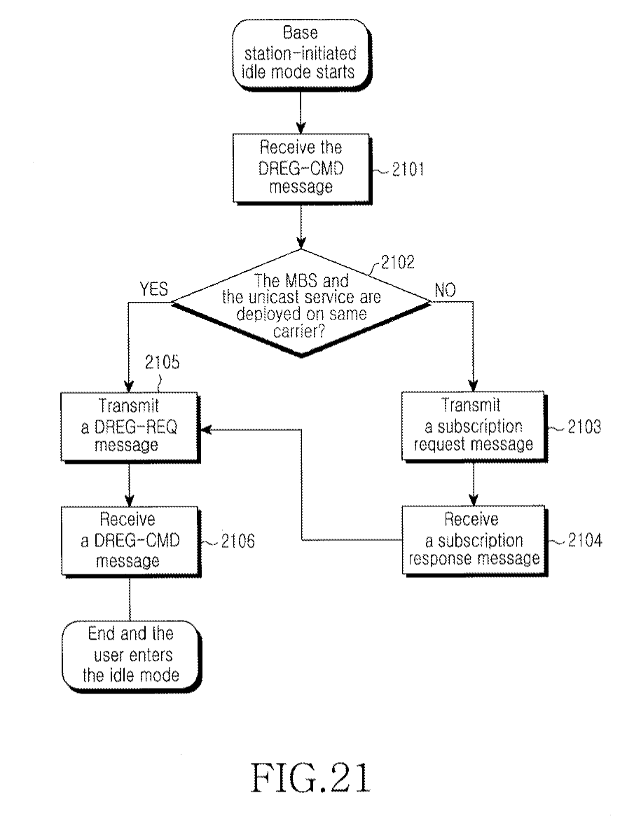

FIG. 21 illustrates user actions in a signal flow for entering an idle mode initiated by a BS according to an exemplary embodiment of the present invention.

Referring to FIG. 21, at step 2101, if the user receives from the BS a DREG-CMD message including a REQ-Duration field, the user performs different actions according to the deployment of the MBS and the unicast service.

At step 2102, the user determines if the MBS and the unicast service are deployed on same carrier. If it is determined that the MBS and the unicast service are deployed on same carrier, the user proceeds with step 2105. Otherwise the user proceeds with step 2103.

At step 2103, the user constructs a subscription request message and transmits it to the MCBCS server.

At step 2104, the user receives a subscription response message from the MCBCS server.

At step 2105, the user waits until the time duration specified by the REQ-Duration has passed, then transmits a DREG-REQ message to the BS.

At step 2106, after receiving again a DREG-CMD message from the BS, the user de-registers from the BS and enters the idle mode.

As discussed above, FIG. 16 illustrates actions of an MCBCS server and FIG. 17 illustrates actions of an AAA server according to exemplary embodiments of the present invention. The actions of the MCBCS server and the AAA server for entering the idle mode are substantially the same regardless if the idle mode is entered at the initiation of the user or the BS. Accordingly, they will not be described again for sake of convenience.

In the present invention, each of the base station, the mobile station, the AAA, the MCBCS server includes an own transceiver for exchanging the above messages for each other and an own controller for generating/analyzing the above messages. An detail operation of the transceiver and the controller is according to the above description.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for idle mode notification by a Base Station (BS) in a cellular communications system, the method comprising:
configuring a Multicast/Broadcast Service MAP (MBS-MAP) for MBS; and
transmitting an idle mode notification to at least one user in an idle mode using the MBS-MAP,
wherein the idle mode notification indicates that the user at least one of waits for the next MBS-MAP and switches to a unicast channel to perform network reentry.

2. The method of claim 1, further comprising:
receiving a De-REGistration REQuest (DREG-REQ) message from the user before the user enter the idle mode; and
transmitting a Dynamic Service Addition REQuest (DSA-REQ) message to the user and adding the user to a multicast group for the idle mode.

3. The method of claim 2, further comprising, if an MBS and a unicast service are deployed on different channels:
receiving, from the user, a DSA-ReSPonse (DSA-RSP) message after transmitting the DSA-REQ message;
transmitting a DSA-ACKnowledgement (DSA-ACK) message to the user after receiving the DSA-RSP message; and
transmitting a De-REGistration CoMmanD (DREG-CMD) message to the user, to instruct the user to de-register from the BS and enter the idle mode after receiving the DREG-CMD message.

4. The method of claim 3, wherein, the DREG-CMD message transmitted by the BS comprises a REQ-Duration field indicating a time period during which the BS continues waiting for the DREG-REQ message from the user.

5. The method of claim 2, further comprising, if an MBS and a unicast service are deployed on the same channel:
transmitting a DSA-REQ message to the user after receiving the DREG-REQ message from the user; and
transmitting a DREG-CMD message to the user to instruct the user to de-register from the BS and enter the idle mode after receiving the DREG-CMD message.

6. The method of claim 1, further comprising, if an MBS and a unicast service are deployed on different channels:
transmitting a DREG-CMD message to the user;
receiving a DREG-REQ message from the user; and
transmitting a DREG-CMD message to the user, to instruct the user to de-register from the BS and enter the idle mode after receiving the DREG-CMD message.

7. The method of claim 6, wherein, the DREG-CMD message transmitted by the BS comprises a REQ-Duration field indicating a time period during which the BS continues waiting for the DREG-REQ message from the user.

8. The method of claim 1, further comprising, if an MBS and a unicast service are deployed on the same channel:
receiving a DREG-REQ message from the user; and
transmitting a DREG-CMD message to the user, to instruct the user to de-register from the BS and enter the idle mode after receiving the DREG-CMD message.

9. The method of claim 1, wherein the transmitting of the idle mode notification comprises:
transmitting, to the user, the MBS-MAP from which the transmission position for the idle mode notification is found and the time is found for the next MBS-MAP; and
transmitting, to the user, the idle mode notification at the transmission position for the idle mode notification.

10. The method of claim 1, wherein the idle mode notification includes at least one of an identifier of the user and an action code.

11. A method for receiving an idle mode notification by a user in a cellular communications system, the method comprising:
entering an idle mode;
receiving, from a Base Station BS, an idle mode notification using a Multicast/Broadcast Service MAP (MBS-MAP) for an MBS; and
switching to a unicast channel to perform network reentry if the idle mode notification comprises a network reentry notification.

12. The method of claim 11, further comprising:
transmitting a De-REGistration REQuest (DREG-REQ) message to the base station before entering the idle mode; and
receiving a Dynamic Service Addition-REQuest (DSA-REQ) message from the base station.

13. The method of claim 12, wherein the entering of the idle mode comprises, if an MBS and a unicast service are deployed on different channels:
transmitting a DSA-ReSPonse (DSA-RSP) message to the base station after receiving the DSA-REQ message;
receiving a DSA-ACKnowledgment (DSA-ACK) message from the base station; and
receiving a De-REGistration CoMmanD (DREG-CMD) message from the BS, de-registering from the BS and entering the idle mode after receiving the DREG-CMD message.

14. The method of claim 13, wherein the DREG-REQ message is transmitted to the BS after a time duration specified by a REQ-Duration field included in the DREG-CMD message.

15. The method of claim 12, wherein the entering of the idle mode comprises, if an MBS and a unicast service are deployed on the same channel:
receiving a DSA-REQ message from the base station after transmitting the DREG-REQ message;
receiving a DREG-CMD message from the BS;
de-registering from the BS; and
entering the idle mode after receiving the DREG-CMD message.

16. The method of claim 11, wherein the entering of the idle mode comprises, if an MBS and a unicast service are deployed on different channels:
transmitting a subscription request message to an MCBCS server before entering the idle mode,
wherein the MCBCS server adds the mobile station into a multicast group for the idle mode.

17. The method of claim 16, wherein the entering of the idle mode comprises, if an MBS and a unicast service are deployed on different channels:
receiving a DREG-CMD message from the BS and transmitting the subscription request message to the MCBCS server;
receiving a subscription response message from the MCBCS server, if an authentication and authorization process between the MCBCS server and an Accounting Authentication Authorization (AAA) server based on user information is successful;
transmitting a DREG-REQ message to the BS; and
receiving a DREG-CMD message from the BS, de-registering from the BS and entering the idle mode after receiving the DREG-CMD message.

18. The method of claim 17, wherein the DREG-REQ message is transmitted to the BS after a time duration specified by a REQ-Duration field included in the DREG-CMD message.

19. The method of claim 11, wherein the entering of the idle mode comprises, if an MBS and a unicast service are deployed on same channel:
transmitting a subscription request message for the MBS to an MCBCS server;
transmitting a DREG-REQ message to the BS after receiving a subscription response message from the MCBCS server; and
receiving a DREG-CMD message from the BS, de-registering from the BS and entering the idle mode after receiving the DREG-CMD message.

20. The method of claim 11, wherein the receiving of the idle mode notification comprises:
receiving, from the BS, the MBS-MAP from which the transmission position for the idle mode notification is found and the time is found for the next MBS-MAP; and
receiving, from the BS, the idle mode notification at the transmission position for the idle mode notification.

21. The method of claim 11, further comprising:
evaluating the idle mode notification; and
waiting for the next MBS-MAP including an idle mode notification, if at least one of the idle mode notification does not include an identifier of the mobile station and the idle mode notification includes the identifier of the mobile station and an action code included in the idle mode notification indicates no action.

22. An apparatus of a Mobile Station (MS) for receiving idle mode notification in a cellular communications system, the apparatus comprising:
a transceiver for receiving, from a Base Station (BS), an idle mode notification using a Multicast/Broadcast Service MAP (MBS-MAP) for an MBS when the mobile station enters an idle mode; and
a controller for switching to a unicast channel to perform network reenter if the idle mode notification is a network reenter notification.

23. The apparatus of claim 22, wherein the transceiver transmits a De-REGistration-REQuest (DREG-REQ) message to the BS before entering the idle mode, and receives a Dynamic Service Addition-REQuest (DSA-REQ) message from the BS.

24. The apparatus of claim 23, wherein, if an MBS and a unicast service are deployed on different channels, the transceiver transmits a DSA-ReSPonse (DSA-RSP) message to the BS after receiving the DSA-REQ message, receives a DSA-ACKnowledgement (DSA-ACK) message from the BS, and receives a De-REGistration CoMmanD (DREG-CMD) message from the BS, for de-registering from the BS and entering the idle mode after receiving the DREG-CMD message.

25. The apparatus of claim 24, wherein the DREG-REQ message is transmitted to the BS after a time duration specified by a REQ-Duration field included in the DREG-CMD message.

26. The apparatus of claim 23, wherein, if an MBS and a unicast service are deployed on the same channel, the transceiver receives a DSA-REQ message from the BS after transmitting the DREG-REQ message, and receives a DREG-CMD message from the BS, and
wherein the controller de-registers from the BS in response to the DREG-CMD and enters the idle mode after receiving the DREG-CMD message.

27. The apparatus of claim 22, wherein, if an MBS and a unicast service are deployed on different channels, the transceiver transmits a subscription request message to an MCBCS server before entering the idle mode, and
wherein the MCBCS server adds the MS into a multicast group for the idle mode.

28. The apparatus of claim 27, wherein, if an MBS and a unicast service are deployed on different channels, the transceiver receives a DREG-CMD message from the BS and transmits the subscription request message to the MCBCS server, receives a subscription response message from the MCBCS server, if an authentication and authorization process between the MCBCS server and an Accounting Authentication Authorization (AAA) server based on user information is successful, transmits a DREG-REQ message to the BS, and receives a DREG-CMD message from the BS, and
wherein the controller de-registers from the BS in response to the DREG-CMD message and enters the idle mode after receiving the DREG-CMD message.

29. The apparatus of claim 28, wherein the DREG-REQ message is transmitted to the BS after a time duration specified by a REQ-Duration field included in the DREG-CMD message.

30. The apparatus of claim 22, wherein, if an MBS and a unicast service are deployed on the same channel, the transceiver transmits a subscription request message for the MBS to an MCBCS server, transmits a DREG-REQ message to the BS after receiving a subscription response message from the MCBCS server, and receives a DREG-CMD message from the BS, and
wherein the controller de-registers from the BS in response to the DREG-CMD message and enters the idle mode after receiving the DREG-CMD message.

31. The apparatus of claim 22, wherein the transceiver receives, from the BS, the MBS-MAP from which the transmission position for the idle mode notification is found and the time is found for the next MBS-MAP, and receives, from the BS, the idle mode notification at the transmission position for the idle mode notification.

32. The apparatus of claim 22, wherein the controller evaluates the idle mode notification, and waits for the next MBS-MAP including an idle mode notification, if at least one of the idle mode notification does not include an identifier of the mobile station and the idle mode notification includes the identifier of the mobile station and an action code included in the idle mode notification indicates no action.
